(19) United States
(12) Patent Application Publication
(10) Pub. No.: US 2013/0238609 A1
(43) Pub. Date: Sep. 12, 2013

(54) QUERY RESULT RENDERING

(71) Applicants: Daniel Marantz, Bellevue, WA (US); Keith A. Regier, Kirkland, WA (US); Sheikh Farhan Ali Saleem, Bellevue, WA (US); Craig Jeffrey Miller, Mill Creek, WA (US); Sarvesh Nagpal, Seattle, WA (US); Manuel Tan, New York, NY (US); Laura Jean Kern, Seattle, WA (US)

(72) Inventors: Daniel Marantz, Bellevue, WA (US); Keith A. Regier, Kirkland, WA (US); Sheikh Farhan Ali Saleem, Bellevue, WA (US); Craig Jeffrey Miller, Mill Creek, WA (US); Sarvesh Nagpal, Seattle, WA (US); Manuel Tan, New York, NY (US); Laura Jean Kern, Seattle, WA (US)

(73) Assignee: Microsoft Corporation, Redmond, WA (US)

(21) Appl. No.: 13/414,023

(22) Filed: Mar. 7, 2012

(51) Int. Cl. G06F 17/30

(52) U.S. Cl. 707/723; 707/722; 707/E17.014

(57) ABSTRACT

Among other things, one or more techniques and/or systems are disclosed for rendering query results. After a user submits a query, a plurality of query results may be received, comprising at least a first query result and a second query result. The first query result can be rendered in a first collapsed view, which may be smaller and may comprise less information than a full view of the first query result. Upon receiving a first indication of scrolling, hinting that the user may wish to view more results, the first query result can be rendered in a first expanded view, which may comprise a full view of the first query result. Further, upon receiving the first indication of scrolling, the second query result can be rendered in a second collapsed view. Rendering query results as provided herein allows a (limited) viewable area to be used in an efficient manner.

### BACKGROUND

Web-based searching for information can utilize a search engine to perform queries on the Internet as well as other data sources, such as a distributed database. The search engine typically includes a user interface which enables query terms to be input and results to be returned for a query. Search queries can return many (e.g., millions) of results for common terms, of which, merely a portion can be displayed a results page. Further, query results can comprise varied elements, such a title of a linked webpage, a snippet of information from the webpage, a hyperlink to the webpage, embedded images, audio, video and other media content as well as rich interactive content.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Typical search engine users have display screens that are merely able to display a very small portion of results returned from a query. Mobile computing devices often comprise a relatively small screen, which may further reduce a number of results viewable in a results page. As such, a display screen may support a limited number of results without moving to a next page. Additionally, search engines often display ads, a page header and other rich/interactive elements, which may also reduce the available space in a viewable area of the results page. It may be appreciated that reducing the number of results displayed on a results page may adversely impact a user experience as the user may be forced to look through multiple result pages and/or may miss desired query results.

Accordingly, among other things, one or more techniques and/or systems are disclosed improving a number of returned results displayed in a results page. A returned query result can be compressed to a smaller form that may still provide enough information for a user to make a comparison to other results, for example. Further, compressing one or more results may result in additional space in the viewable area, or rather an efficient use of a finite/fixed amount of space, which may allow for additional results to be displayed. Additionally, as the user hints at wanting to see more results (e.g., scrolls up or down), the compressed results may be expand to comprise a full result, showing more information about that result, for example. In response to an indication of scrolling up, for example, additional compressed results can be made available near a bottom of the page, for example, providing more displayed results on the page.

In one embodiment of rendering query results, at least a first query result and a second query result can be received (e.g., a plurality of results). Further, the first query result can be rendered in a first collapsed view, such that the first collapsed view comprises less information than an expanded (e.g., full) view. Upon receiving a first indication of scrolling, the first query result can be rendered in a first expanded view, such as comprising a full view of the first query result. Additionally, the second query result can be rendered in a second collapsed view, upon receiving the first indication of scrolling.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for rendering query results.

FIGS. 2A and 2B illustrate example embodiments of query results where one or more portions of one or more techniques described herein may be implemented.

FIG. 3 is a flow diagram illustrating an example embodiment where one or more portions of one or more techniques described herein may be implemented.

FIG. 4 is a flow diagram illustrating an example embodiment where one or more portions of one or more techniques described herein may be implemented.

FIGS. 5A and 5B illustrate example embodiments of a search engine results page where one or more portions of one or more techniques described herein may be implemented.

FIG. 6 illustrates an example embodiment of a search engine results page where one or more portions of one or more techniques described herein may be implemented.

FIG. 7 is a component diagram illustrating an exemplary system for rendering query results.

FIG. 8 is a component diagram illustrating an example embodiment where one or more systems described herein may be implemented.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, a method may be devised that provides for displaying query results, such as on a search engine results page (SERP), in an efficient manner. One or more query results may be collapsed from a typical expanded view, such as at a bottom (and/or top) of a viewing area of the SERP. In this way, additional viewing area may be created in which additional query results may be rendered. When the SERP is scrolled, for example, results at a top (and/or bottom) of the SERP may be removed, and previously collapsed results can be expanded into a typical expanded view. The viewing area of the SERP may be progressive, such that additional, collapsed view results can be added at the bottom (and/or top) of the SERP when scrolling.

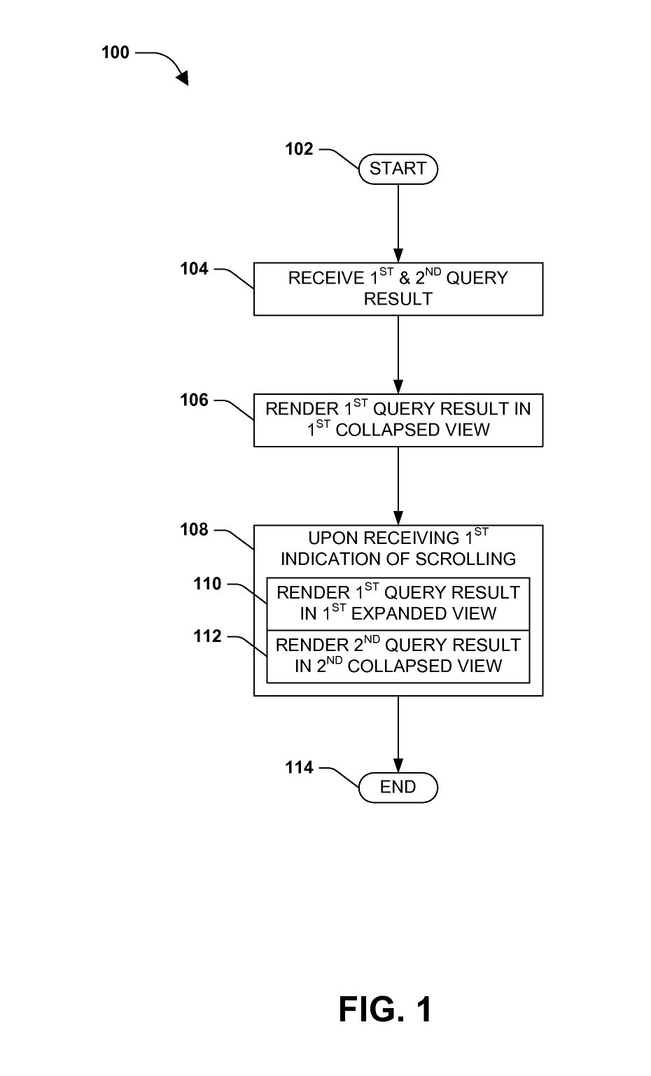

FIG. 1 is a flow diagram illustrating an exemplary method 100 for rendering query results. The exemplary method 100 begins at 102. At 104, at least a first query result and a second query result are received (e.g., such as by a search engine results page (SERP) rendering component). As one example, a user may enter one or more query terms into an online search engine page, which, in turn, may return one or more search results related to the one or more query terms. Further, a SERP may be returned as a result of a query, where the SERP comprises one or more elements, such as query results. In one embodiment, prior to displaying the SERP to the user, the first and second query results can be received and rendered (e.g., for subsequent display).

At 106 in the exemplary method 100, the first query result is rendered in a first collapsed view. Typical query results on a SERP, for example, comprise at least a header (e.g., a title of a page linked to the result), a body (e.g., a snippet of information from the page linked to the result), and a footer (e.g., a hyperlink to the page linked to the result). In one embodiment, rendering a collapsed view (e.g., the first collapsed view) may comprise removing at least a body portion from a view of a query result. In one embodiment, rendering the collapsed view may comprise rendering merely a header and a footer in the view of the query result (although rendering a collapsed view in different manners is also contemplated herein).

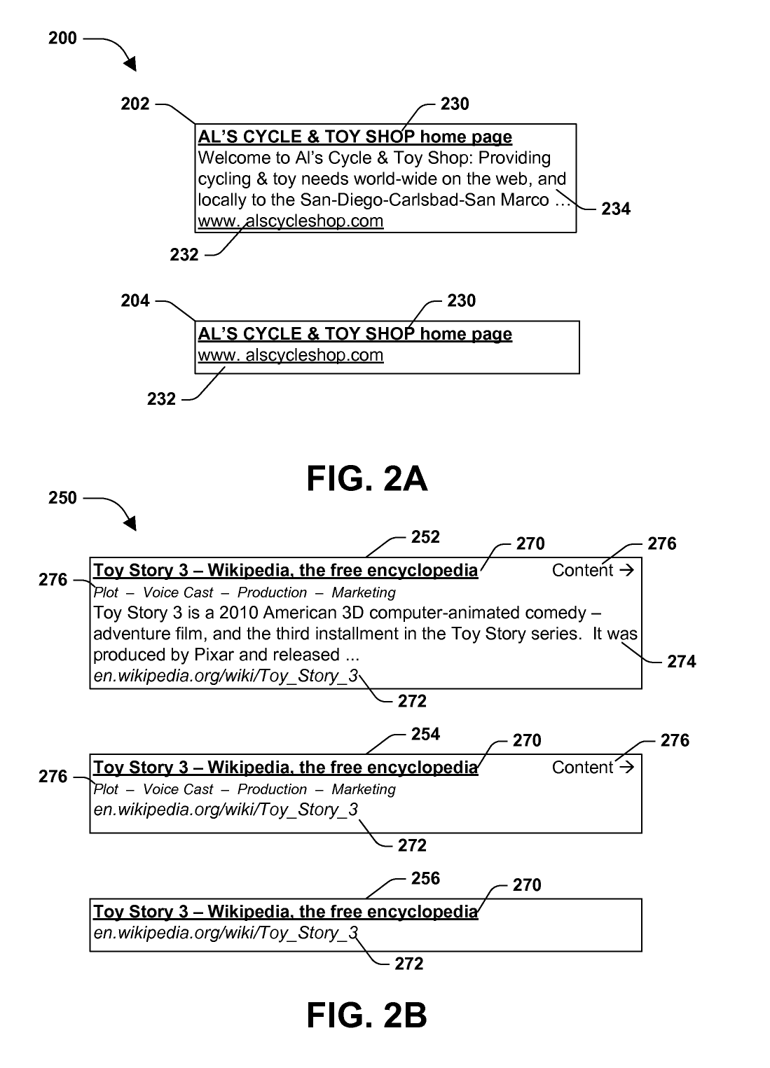

As an illustrative example, FIGS. 2A and 2B illustrate example embodiments 200 and 250 of query results where one or more portions of one or more techniques described herein may be implemented. In the example embodiment 200, a typical view 202 (e.g., an expanded view) of a query result comprises a header 230, indicating a title of the linked page; a body 234, indicating a snippet of information from the linked page; and a footer 232, indicating a hyperlink to the linked page. Further, an example collapsed view 204 comprises merely the header 230, and the footer 232. In this example, the body 234 has been removed in the collapsed view 204.

The example embodiment 250 comprises one example of a “rich” query result (e.g., more interactive than a typical result, and/or comprising additional content). In this example embodiment 250, a typical view 252 (e.g., expanded view) of the query result for “Toy Story 3” comprises a header 270, additional “rich content” 276 (e.g., interactive content), a body 274, and a footer 272. In one embodiment, in a first collapsed view 254, the body 274 may be removed, and the result may comprise the header 270, the rich content 276 and the footer 272. In another embodiment, in a second collapsed view 256, the example result may merely comprise the header 270 and the footer 272.

Returning to FIG. 1, at 108, upon receiving a first indication of scrolling, the first query result is rendered in a first expanded view, at 110. As one example, when a rendered SERP is displayed on a display screen, at least a portion of the SERP may not be visible on the display. In this example, a user may scroll (e.g., input a scroll command, such by as rolling a mouse wheel, selecting a scroll graphical user interface on the display, inputting a “page down” command, etc.) the displayed SERP in order to display the “off-screen” portion of the SERP. In one example, the first query result may rendered in the first expanded view (e.g., 202 of FIG. 2A, 252 of FIG. 2B), when the scroll is indicated, and displayed on the display screen.

In one embodiment, rendering the first expanded view (e.g., a second expanded view, a third expanded view, etc.) can comprise rendering at least a body portion of a view of a query result. In one embodiment, rendering the first expanded view can comprise rendering at least a header and a footer of the view of the query result. As an illustrative example, in FIG. 2A, the example view 202 may comprise an expanded view of the query result. In this example, the expanded view 202 comprises the header 230 of the result, the body 234 of the result, and the footer 232 of the result. Further, as an example, in FIG. 2B, an example expanded view 252 of a result comprises the header 270, the additional rich content 276, the body 274 and the footer 272. In one embodiment, the example expanded view, such as 254, may comprise the header 270, the rich content 276 and the footer 272, for example, without the body 274.

Returning to FIG. 1, at 112, upon receiving the first indication of scrolling, at 108, the second query result is rendered in a second collapsed view. As one example, the received second query result can be rendered and displayed in the second collapsed view (e.g., 204 of FIG. 2A, 254 or 256 of FIG. 2B) on a display screen. In this example, the first query result can be displayed on the SERP in the first expanded view, and the second query result can be displayed on the SERP in the second collapsed view. In this way, for example, the SERP may comprise additional display space (e.g., as compared to a typical SERP comprising merely expanded results), which may allow additional query results to be rendered and displayed. It may be appreciated that prior to receiving the first indication of scrolling, the second query result may be expanded or already collapsed (e.g., on or off the SERP).

Having rendered the first query result in the first expanded view, and the second query result in the second collapsed view, the exemplary method 100 ends at 114.

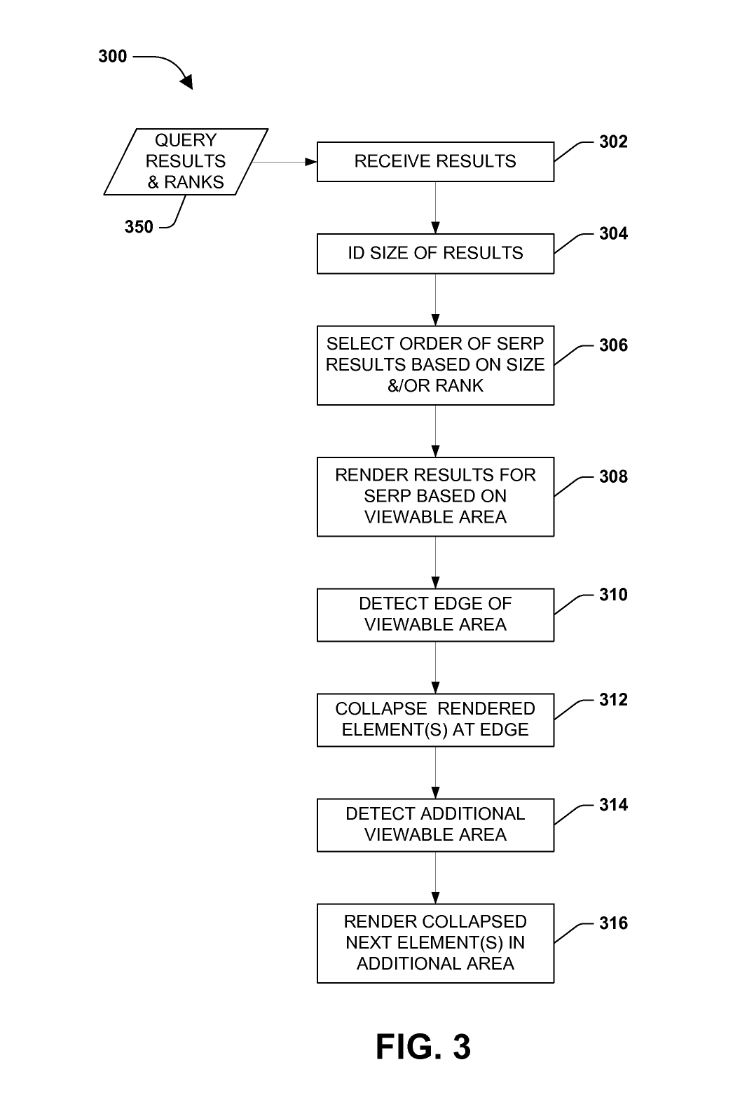

FIG. 3 is a flow diagram illustrating an example embodiment where one or more portions of one or more techniques described herein may be implemented. At 302 in the example embodiment 300, one or more query results 350, and a corresponding result ranking for the respective one or more query results 350, can be received. As one example, a search engine results page (SERP) rendering engine may receive the one or more query results 350 and ranks, resulting from a query comprising one or more query terms. For example, a ranking may comprise a level of relevance assigned to a corresponding result, as determined by a search engine from the query terms.

At 304, a size of the respective one or more query results 350 can be identified. In one embodiment, identifying the size can comprise identifying a size of an expanded view of a query result (e.g., 202 of FIG. 2A, 252 of FIG. 2B). As an example, a typical SERP may comprise a plurality of ranked query results in their respective expanded (e.g., typical) view, such as comprising a header, body and footer (e.g., and some additional rich content). In one embodiment, a size of the respective one or more received query results 350 can be identified in their respective expanded views. In this way, for example, a determination may be made as to how many of the received query results 350 may fit on a first page (e.g., an initially rendered page view) of returned query results, should the results be presented in the respective expanded views.

At 306 in the example embodiment 300, an order of the received query results 350 may be determined, based at least upon their respective rankings, and/or their respective sizes. As one example, typical search engines rank query results according to one or more relevance algorithms, which may produce results relevant to the user. Further, as an example, different query results may comprise different respective sizes based upon the content of the results. As an illustrative example, the “rich” result view 252 of FIG. 2B comprises the additional rich content 276, which may increase the size of this result view 252 over the typical result 202 of FIG. 2A, which merely comprises the header 230, body 234 and footer 232. Additionally, some results may comprise additional media, such as imbedded images, graphics and/or video stills, which provide more different sized results.

In one embodiment, a size of a viewable area of a display within which the results may be rendered can be identified. In this embodiment, for example, the size of the viewable area may determine how many of the received results can be displayed on a first page of the resulting SERP. That is, for example, the larger the size of the results, the fewer the number of results can be rendered on the first page. In one embodiment, determining the order of the received results to display may comprise adjusting the display order by applying a ranking penalty to “oversized” results. As an example, a first result that comprises rich content and/or embedded images, resulting in a larger size, may be weighted in such a way that pushes it down in a rendering order, compared to a “typical” result that is smaller, and has a similar, but lower, ranking. It may be appreciated, however, that the size of the results does not impact the order of the results, which is fixed per the respective relevance of the different results. Rather, the order within which results are displayed may be adjusted based upon the respective size of different results, for example.

At 308, the received results for the SERP can be rendered, in the selected order, based upon the size of the viewable area of the display. As one example, the respective received results that fit onto the first page of the SERP can be rendered in their corresponding expanded view to appropriately fill the viewable area of the display. In one embodiment, the initial page of the SERP may be rendered, but not displayed, for example, in order to determine an arrangement of the results on the page (e.g., which results border an edge of the page).

At 310, an edge of the viewable area may be identified. As one example, the edge of the viewable area may comprise a bottom edge of the viewable area, such that the first page may comprise a first result at a top of the page, and a last (viewable) result at the bottom edge of the page (e.g., top to bottom ranking). In one embodiment, the edge of the viewable area may comprise a top edge of the of the viewable area, and/or one or both side edges of the viewable area.

At 312, one or more rendered elements (e.g., results) may be collapsed at or near one or more of the detected edges of the viewable area, for example, such that one or more rendered elements (e.g., first element at the edge, first two elements at the edge, or more) are rendered in a collapsed view. At 314, additional viewable area of the display can be detected, which may result from collapsing the one or more results at the edge(s) of the viewable area. At 316, a next element (e.g., a third result) can be rendered in a collapsed view (e.g., a third collapsed view) in the detected additional viewable area. For example, a result that may not have been rendered in the viewable area initially, due to the size of the rendered results, may be moved from outside the viewable area to inside the viewable area due to the creation of the additional viewing area (from collapsing one or more results).

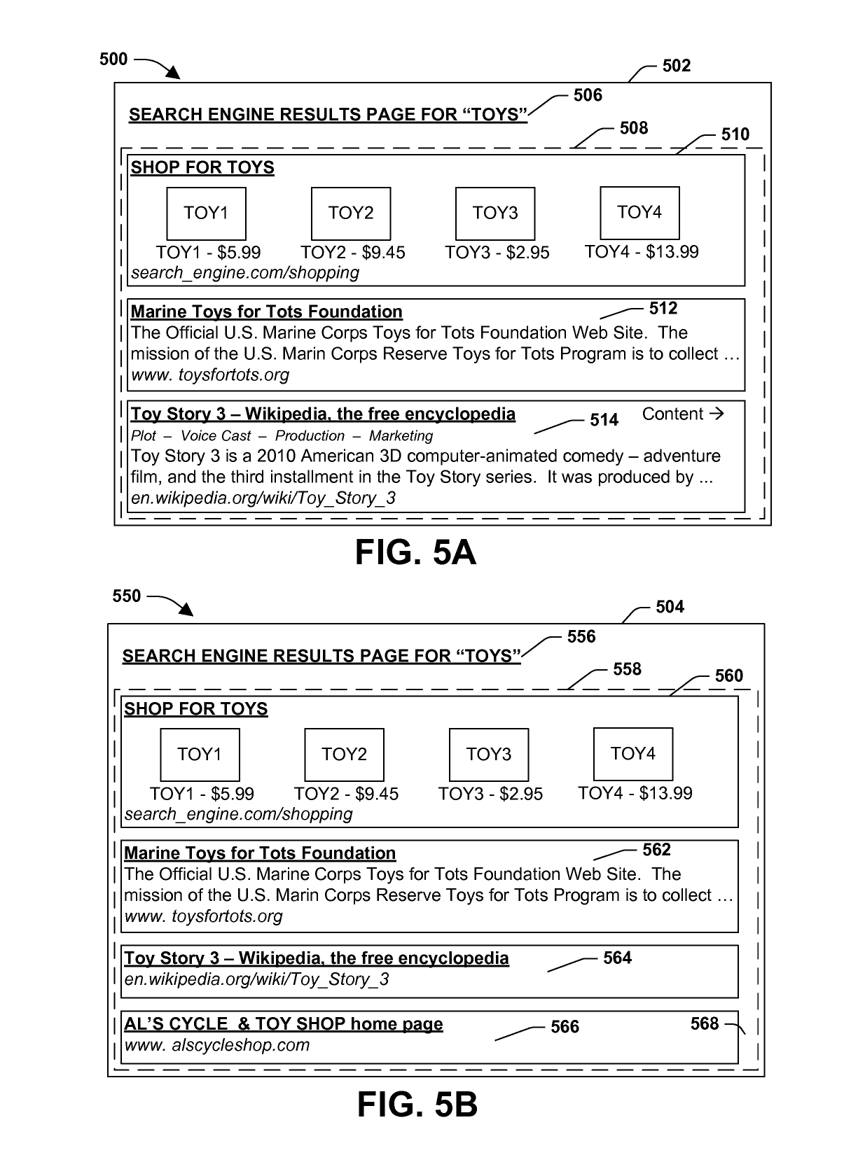

As an illustrative example, FIGS. 5A and 5B illustrate example embodiments 500, 550 of a search engine results page (SERP) 502 where one or more portions of one or more techniques described herein may be implemented. In the example embodiment 500 of FIG. 5A, the SERP 502 comprises results returned for a query comprising “toys” 506. Further, a viewable area 508 comprises an area in which returned results 510, 512, 514 may be rendered. In this example, the respective results 510, 512, 514 are rendered in their respective “expanded” views. For example, the result 510 comprises embedded images of toys and prices; the result 512 comprises a header, body and footer; and the result 514 comprises a header, body and footer, as well as additional rich content.

In the example embodiment 550 of FIG. 5B, a SERP 504 also comprises results returned for a query comprising “toys” 556. However, in this example 550, the viewable area 558 comprises four results 560, 562, 564, 566, due to additional viewing area 568 created by rendering the result 564 in a collapsed view (e.g., comprising merely a header and footer). The result 566 comprising “Al's Cycle & Toy Shop” may not have fit into the viewable area 508 of the SERP 502 (in FIG. 5A), and, therefore, may have been rendered out of view of the viewable area 508. However, when the additional viewing area 568 was created, the “next” result outside of the viewable area 558 of the SERP 504 can be rendered inside the viewable area 558, in the collapsed view.

It will be appreciated that the techniques described herein are not limited to the embodiments described herein. For example, more than one result may be collapsed at the detected edge of the viewable area, thereby creating enough additional viewing area to render more than one “next” result, such as in a collapsed (or expanded) view, for example. Further, one or more results may be collapsed at a top edge (e.g., and/or a side edge(s), depending on screen orientation, display preference, rendering order, etc.), and corresponding “next” results can be rendered in additional viewing area(s) resulting therefrom.

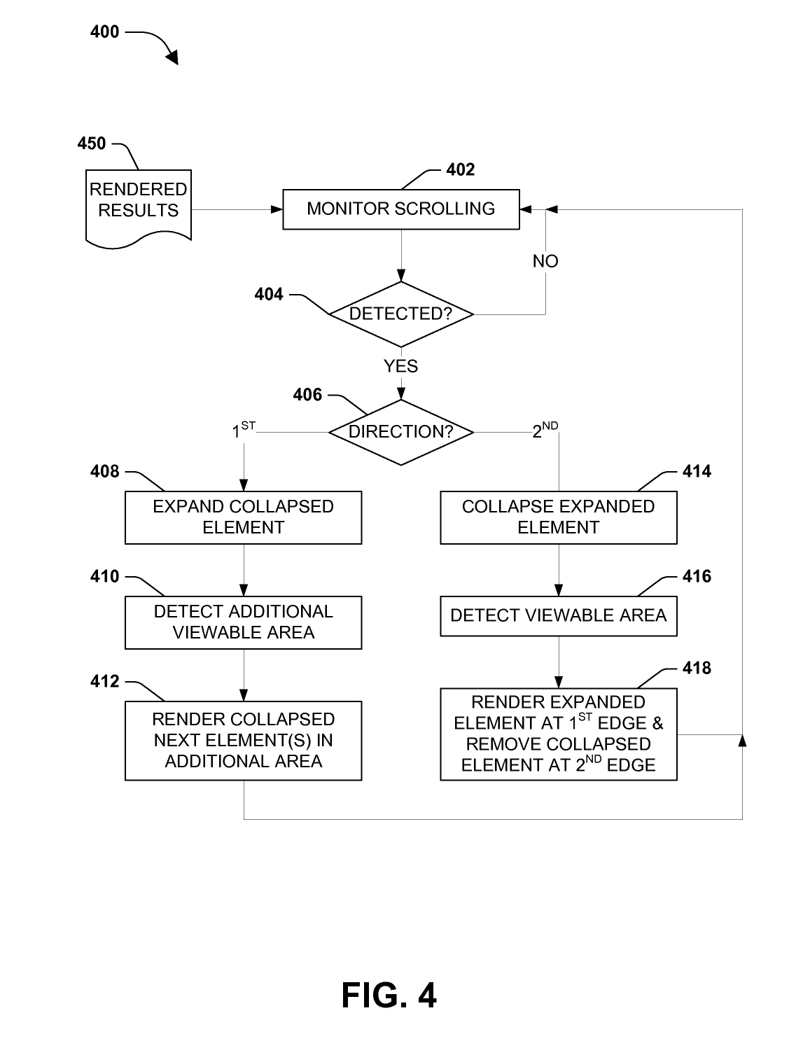

FIG. 4 is a flow diagram illustrating an example embodiment 400 where one or more portions of one or more techniques described herein may be implemented. At 402, a SERP, comprising rendered results 450, some of which may be expanded while others may be collapsed, can be monitored to identify if a scrolling indication is received. As one example, when a “page” of a document (e.g., a web-page) is rendered and displayed on a display screen, not “all” of the content comprised in the rendered page may be able to be displayed, and/or merely content within a viewable portion of the page is rendered for display. When a page comprises off-screen content (e.g., outside the viewable area), for example, the page may be “scrolled” by a user to bring the “off-screen” content within the viewable area. “Scrolling” may be considered a form of panning, for example, where the viewable area (e.g., a view window) is panned over the content of the page (e.g., or the content is selectively brought into the viewable area).

As one example, an indication of scrolling may occur when a GUI is selected on the display screen (e.g., clicking on a scrolling arrow, sliding a slider bar, etc.), and/or some other scrolling input is received for the page (e.g., a page-up/page-down key, scrolling a mouse wheel, panning arrows selected by a mouse, etc.). When a scrolling indication occurs, at least a portion of the page content is moved off-screen (e.g., outside the viewable area) and another portion of the page content is moved on-screen (e.g., inside the viewable area). If no scrolling indication is received (NO at 404), the page can continue to be monitored for scrolling at 402.

If an indication of scrolling is detected (YES at 404), a direction of the scrolling can be determined. As one example, a SERP may comprise more content (e.g., results) than can be rendered in the viewable area. In this example, the SERP may be set up as a progressive document, such that the content outside the viewable area or window may be viewed by scrolling up or down (e.g., and/or left or right). In one embodiment, a first direction (1st at 406) may comprise scrolling down, such that the content in the viewable area moves up (e.g., and out of the viewable area at a top edge), and off-screen content moves into the viewable area from a bottom edge. Further, in this embodiment, a second direction (e.g., 2nd at 406) may comprise scrolling up, such that the content in the viewable area moves down (e.g., and out of the viewable area at the bottom edge), and off-screen content moves into the viewable area from the top edge.

As an illustrative example, a first view of the SERP 504 may comprise the example embodiment 550 of FIG. 5B. In this example, as described above, two results comprise expanded views 560, 562, and two results comprise collapsed views 564, 566. As one example, if the scrolling direction is the first direction (e.g., scrolling down), the first result 560 may move up and off a top edge of the viewable area 558 (or may be collapsed), thereby creating additional space in the viewing area, into which a “next” result may be rendered and/or a collapsed result (that may be on or off the page) may be expanded.

Returning to FIG. 4, if the direction is the first direction (1st at 406), a first collapsed element (e.g. result) in the rendered results 450 can be expanded, at 408. At 410, additional viewable area can be detected, for example, resulting from removing (or collapsing) an expanded result from a top of the viewable area. Further, at 412, a “next” element (e.g., result) can be rendered inside the viewable area, such as at the bottom edge. For example, when the SERP is scrolled down, an expanded result (e.g., 560 of FIG. 5B) at the top of the viewing area can be removed (or collapsed) from the viewing area, thereby creating room for one of the collapsed results (e.g., 564 of FIG. 5B) to be expanded and/or for one or more of the next off-screen results to be presented in the viewable area (e.g., in a collapsed or expanded view).

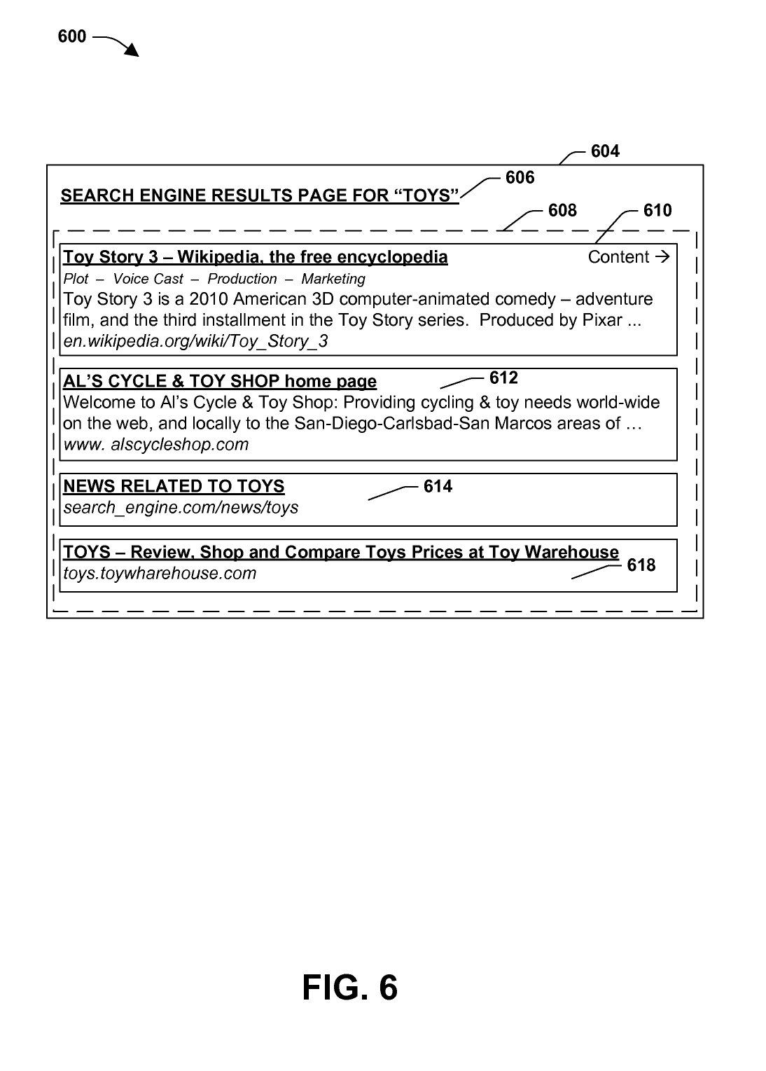

As an illustrative example, FIG. 6 illustrates an example embodiment 600 of a search engine results page where one or more portions of one or more techniques described herein may be implemented. In this example embodiment 600, the SERP 604, comprising the results for the query “toys” 606, may indicate a viewable area 608 after the content has been scrolled down (e.g., from 550 of FIG. 5B). For example, the first two expanded results 560, 562 of FIG. 5B may have been removed at the top edge of the viewable area 608, the previously collapsed results 564, 566 of FIG. 5B now comprise expanded views 610, 612, and two “next” results 614, 618 may have been added at a bottom edge of the viewable area 608 in a collapsed view. In one example, the viewable area 608 may be progressively scrolled down, resulting in the collapsed view results 614, 618 to be rendered in an expanded view, and one or more “next” (e.g., in the result order) results to be rendered in a collapsed view at the bottom edge, thereby allowing for more results to be viewed at a same time in the viewable area (e.g., as compared to non-collapsed views).

Returning to FIG. 4, at 414, if the direction comprises a second direction (e.g., 2nd at 406), an expanded element may be collapsed. At 416, the viewable area may be detected, for example, determining how much of the area is available for rendering the results (e.g., in a collapsed and/or expanded view). Further, at 418, an expanded (or collapsed) view of an element (e.g., an off-screen result) may be rendered at a first edge (e.g., top edge) of the viewable area, and a collapsed view of an element may be removed at a second edge (e.g., the bottom edge) of the viewable area or an expanded view of an element may be collapsed (or removed) at the second edge (e.g., the bottom edge) of the viewable area. As one example, the viewable area of the SERP may be scrolled up, such that one or more results that had previously been scrolled off the top of the page are now scrolled back into the viewable area, and one or more results at the bottom of the page are scrolled off the page at the bottom (or collapsed).

As an illustrative example, the SERP 604 in the example embodiment 600 of FIG. 6 may be scrolled up (e.g., an indication of scrolling in the 2nd direction is received) (e.g., such that the content in the viewable area moves down). As a result, the SERP 504 of FIG. 5B may again be presented comprising expanded views 560, 562 of results that were off-screen prior to the scrolling up (e.g., due to previously being scrolled off the screen, or resulting from an initial rendering of the SERP without the results 560, 562). Further, results 564, 566 are rendered in a collapsed view, such as resulting from collapsing previously rendered expanded views (e.g., 610, 612 of FIG. 6). Additionally, in this example, results that may have been previously rendered in the viewable area in a collapsed view (e.g., 614, 618 of FIG. 6) may be removed at the bottom edge of the viewable area 558.

As one example, as a SERP is scrolled either up or down (e.g., and/or left and right) a view of a result in the viewable area may be expanded and/or collapsed (e.g., and/or removed and/or added) in response to a direction of the scrolling. In this way, for example, the viewable area of a results page may comprise more rendered results than one that does not allow for collapsing results. Returning to FIG. 4, the rendered SERP may be continually monitored for an indication of scrolling, at 402.

In one aspect, while scrolling (panning) the viewable area of a page, a result may be transitioned between a collapsed view and an expanded view. In one embodiment, in this aspect, a transition view of the query result can be rendered between the rendering of the result's collapsed view and the rendering of the result's expanded view. As an illustrative example, in FIG. 2B, a rendered result view 254 may comprise the transition view between a rendered expanded view 252 of the result, and a rendered collapsed view 256 of the result.

In one embodiment, the transition view may comprise a progressive transition between the expanded and collapsed views, relatively proportional to the scrolling. That is, for example, as the page is scrolled, such that the result transitions from the expanded view to the collapsed view, at least a portion of the expanded view may be proportionally collapsed (e.g., portions the body text may be removed from view, then rich content may be removed, if present), until the collapsed view is reached.

In another aspect, a location of the expanded view and/or the collapsed view of the results in the viewable area may be arranged differently. In one embodiment, in this aspect, an initial rendering of the viewable area may comprise one or more results in a collapsed view at a top of the viewable area, one or more results in an expanded view in a middle of the viewable area, and one or more results in the collapsed view at a bottom of the viewable area. In this embodiment, for example, when the viewable area is scrolled, either up or down, one or more of the expanded results can be rendered at the bottom or top of the viewable area (e.g., depending on the direction of scrolling), and one or more of the collapsed results can be expanded in the middle area.

In another embodiment, a rendering of the viewable area may comprise one or more results in a collapsed view at a top of the viewable area, and one or more results in an expanded view at a bottom of the viewable area. In this embodiment, for example, scrolling down (e.g., so that content moves up) may result in one or more of the collapsed results being removed from view, one or more of the expanded results being collapsed, and one or more off-screen results being rendered at the bottom of the viewable area in the expanded (or collapsed) view. Further, for example, scrolling up (e.g., so that content moves down) may result in one or more of the collapsed results being rendered in the expanded view at the bottom of the page, one or more of the expanded results being (collapsed or) removed from view, and one or more off-screen results being rendered at the top of the viewable area in the collapsed (or expanded) view.

A system may be devised that may provide for more query results to be rendered in a viewable area of a page. Where typical query results may comprise an expanded view, one or more of the expanded query results can be collapsed in order to create additional space in the viewable area. As an example, the additional viewable area may be used to render one or more additional results, such as in a collapsed (or expanded) view. Further, when the viewable area of the page is panned (e.g., scrolled up or down), for example, the expanded view of one or more results can be collapsed (e.g., or removed from the viewing area), and one or more of the collapsed results can be expanded. In a progressive page, for example, comprising viewable results and off-screen results, scrolling the viewable area may result in a transition between the collapsed view and expanded view of one or more results, and a transition between viewable results and off-screen results.

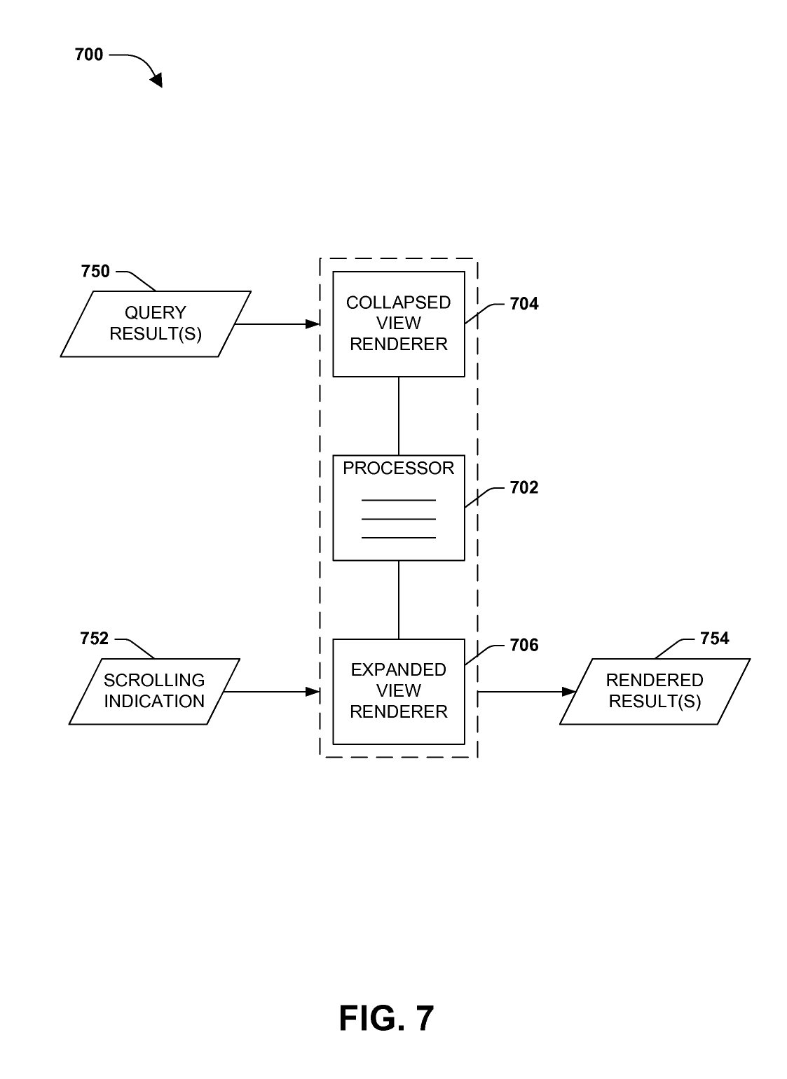

FIG. 7 is a component diagram illustrating an exemplary system 700 for rendering query results. In the exemplary system 700, a computer-based processor 702, configured to process data for the system 700, is operably coupled with a collapsed view rendering component 704. The collapsed view rendering component 704 can be configured to render 754 a received first query result 750 in a first collapsed view. Further, the collapsed view rendering component 704 can be configured to render 754 a received second query result 750 in a second collapsed view upon receiving a first indication of scrolling 752.

The exemplary system 700 further comprises an expanded view rendering component 706 operably coupled with the processor 702. The expanded view rendering component 706 is configured to render 754 the first query result 750 in a first expanded view upon receiving the first indication of scrolling 752. As one example, an initial rendering of a viewable area of a search engine results page (SERP) may comprise the first query result in a first collapsed view (e.g., without a body portion of the result). In this example, upon receiving the first indication of scrolling, the first collapsed view of the first query result may be transitioned to the first expanded view (e.g., comprising a header, footer and the body portion), and the second query result may be rendered in the second collapsed view. As another example, an initial rendering of a viewable area of the SERP may comprise the first query result in the first collapsed view and the second query result in a second expanded view. In this example, upon receiving the first indication of scrolling 752, the second query result may be rendered in the second collapsed view, and the first collapsed view of the first query result may be rendered in the first expanded view.

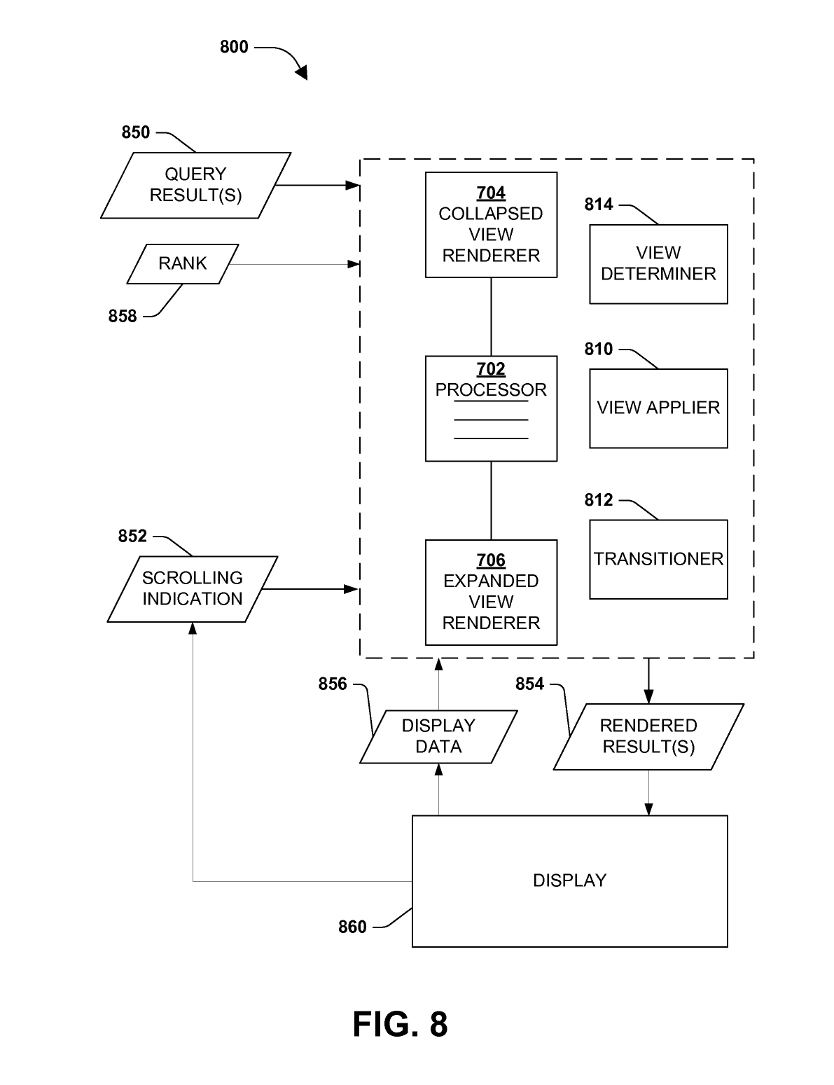

FIG. 8 is a component diagram illustrating an example embodiment 800 where one or more systems described herein may be implemented. In this example 800, an extension of FIG. 7 is provided and thus description of elements, components, etc. described with respect to FIG. 7 may not be repeated for simplicity. In his example embodiment 800, a view application component 810 can be configured to determine a view indication for at least one of the first query result and the second query result 850. The determined view indication can comprise at least one of an expanded view indication and a collapsed view indication.

Determining the view indication for the query result 850 may be based on a ranking of at least one of the first query result and the second query result. As one example, a search engine may return a rank 858 for respective results returned from a query, where the rank may be determined based on a relevance of the result (e.g., relevant to one or more query terms comprised in the query), such that a higher rank may be regarded as result comprising a greater relevance, for example.

Further, determining the view indication for the query result 850 may be based on a size of at least one of a first expanded view of the first query result and a second expanded view of the second query result. As one example, the first expanded view of the first query result may comprise a different size (e.g., more or less content in the result) than the second expanded view of the second query result. In one embodiment, the view application component 810 may provide an indication that the first query result can be rendered in a first collapsed view, and an indication the second query result can be rendered in the second expanded view, if the first expanded view is larger than the second expanded view (e.g., even if the first query result is ranked higher than the second query result).

In the example embodiment 800, a transitioning component 812 can be configured to render a transition view of at least one of the first query result and the second query result. In one embodiment, the transition view can comprise a rendered view of the first query result that is between the rendering of the first collapsed view of the first query result and the rendering of the first expanded view of the first query result.

As one example, the transition view may comprise more content than the first collapsed view, but less content than the first expanded view. For example, the transition view may be rendered progressively (e.g., progressively adding or removing content) between the rendering of the first collapsed view and the rendering of the first expanded view. That is, as an example, when an indication of scrolling 852 is received, the transition view may be rendered progressively in proportion with the indication of scrolling 852.

In the example embodiment 800, a view determination component 814 may be configured to identify display data 856 indicative of a viewable size of a display window 860 (e.g., viewable area) within which query results 854 may be rendered. As one example, a size of a viewable area of the display window 860 may provide an indication of how many results can be rendered 854 in the display window 860, based on a size of the respective results. Further, as an example, the viewable area size of the display window 860 may indicate how many (e.g., and which) results can be rendered in an expanded view, and how many results can be rendered in a collapsed view.

In one embodiment, the collapsed view rendering component 704 can be configured to render the first query result inside a display edge of the viewable area of the display window 860 in the collapsed view. As an example, the view determination component 814 can detect the viewable area, which can comprise one or more display edges (e.g., edges of the viewable area of the display window 860). In this embodiment, for example, the first query result can be rendered inside the viewable area of the display window 860, immediately adjacent to the display edge (e.g., at a bottom of the SERP).

Further, in one embodiment, the collapsed view rendering component 704 can be configured to collapse at least the second query result outside the display edge of the viewable area of the display window 860 in the second collapsed view. As one example, the second query result (e.g., and a third, fourth, etc.) may be rendered 854 in the second collapsed view outside the display edge, such that the second query result is not displayed in the viewable area of the display window 860 (e.g., not displayed, rendered as an off-screen result).

Additionally, the collapsed view rendering component 704 can be configured to render at least the second query result inside the display edge of the viewable area of the display window 860 in the second collapsed view. As one example, upon receiving the indication of scrolling (e.g., scrolling the page down), the collapsed view rendering component 704 can move the second query result into the viewable area of the display window 860, rendered in the second collapsed view.

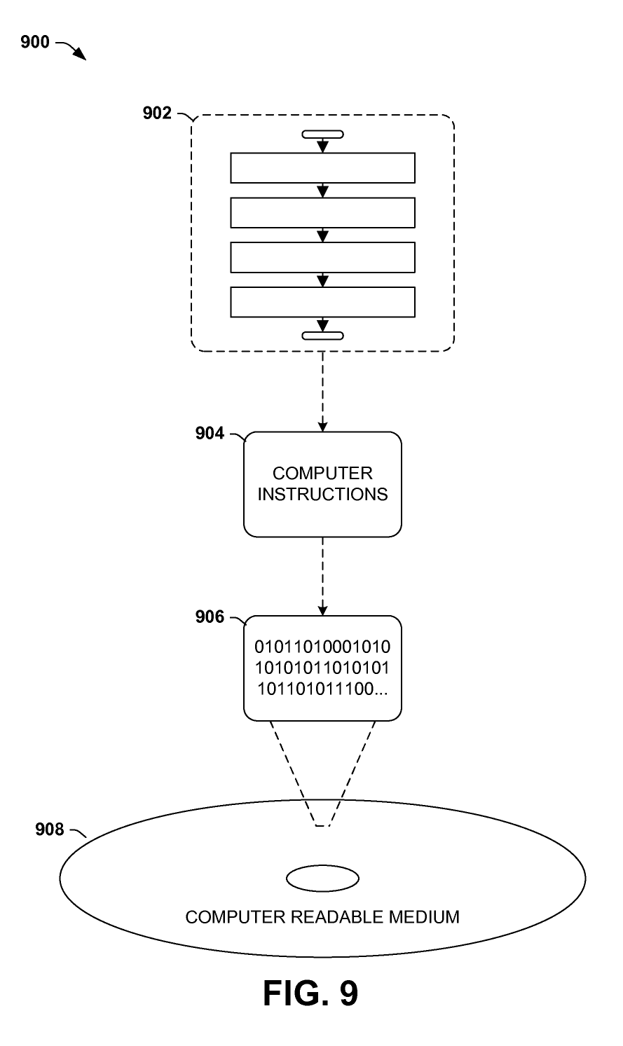

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 908 (e.g., a CD-R, DVD-R, or a platter of a hard disk drive), on which is encoded computer-readable data 906. This computer-readable data 906 in turn comprises a set of computer instructions 904 configured to operate according to one or more of the principles set forth herein. In one such embodiment 902, the processor-executable instructions 904 may be configured to perform a method, such as at least some of the exemplary method 100 of FIG. 1, for example. In another such embodiment, the processor-executable instructions 904 may be configured to implement a system, such as at least some of the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

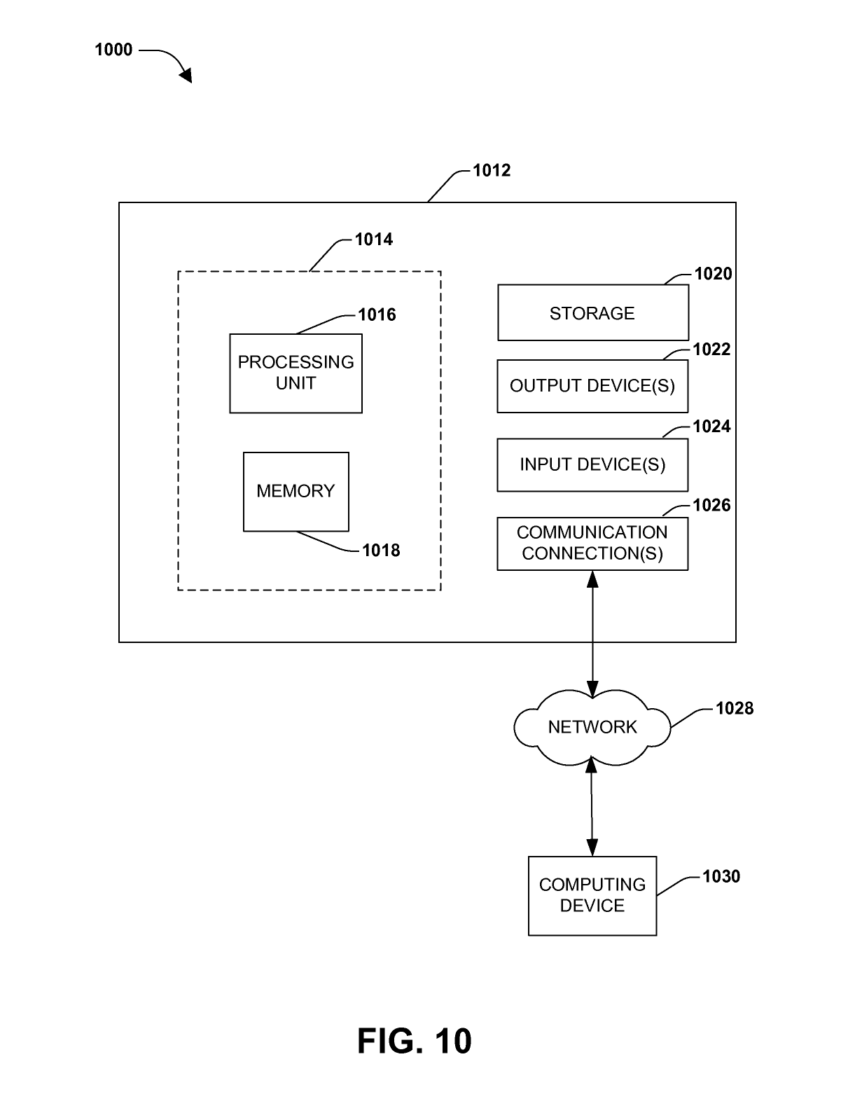

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for rendering query results, comprising:
receiving at least a first query result and a second query result;
rendering the first query result in a first collapsed view; and
upon receiving a first indication of scrolling:
rendering the first query result in a first expanded view; and
rendering the second query result in a second collapsed view, at least a portion of the method performed by a processing unit.

2. The method of claim 1, comprising rendering the second query result in a second expanded view prior to receiving the first indication of scrolling.

3. The method of claim 1, comprising, upon receiving a second indication of scrolling, at least one of:
rendering the second query result in a second expanded view; and
rendering the first query result in the first collapsed view.

4. The method of claim 1, comprising rendering a third query result in a third collapsed view upon receiving at least one of the first indication of scrolling and a third indication of scrolling.

5. The method of claim 1, rendering in a collapsed view comprising removing at least a body portion from a view of a query result.

6. The method of claim 5, rendering in the collapsed view comprising rendering merely a header and a footer in the view of the query result.

7. The method of claim 1, rendering in an expanded view comprising rendering at least a body portion of a view of a query result.

8. The method of claim 7, rendering in the expanded view comprising rendering at least a header and a footer of the view of the query result.

9. The method of claim 1, comprising identifying a ranking of at least one of a third query result and a fourth query result.

10. The method of claim 9, comprising rendering the third query result in a third expanded view and the fourth query result in a fourth collapsed view if the third query result comprises a higher ranking than the fourth query result.

11. The method of claim 1, comprising identifying a size of a third expanded view of a third query result.

12. The method of claim 11, comprising rendering the third expanded view of the third query result based upon the size.

13. The method of claim 1, comprising rendering a transition view of the first query result between the rendering of the first collapsed view of the first query result and the rendering of the first expanded view of the first query result.

14. A system for rendering query results, comprising:
a collapsed view rendering component configured to perform one or more of:
render a received first query result in a first collapsed view; and
render a received second query result in a second collapsed view upon receiving a first indication of scrolling; and
an expanded view rendering component configured to render the first query result in a first expanded view upon receiving the first indication of scrolling, at least some of at least one of the collapsed view rendering component and the expanded view rendering component implemented at least in part via a processing unit.

15. The system of claim 14, comprising a view application component configured to determine a view indication for at least one of the first query result and the second query result, the view indication comprising at least one of an expanded view indication and a collapsed view indication, based at least upon one or more of:
a ranking of at least one of the first query result and the second query result; and
a size of at least one of the first expanded view of the first query result and a second expanded view of the second query result.

16. The system of claim 14, comprising a transitioning component configured to render a transition view, the transition view comprising a view of the first query result between the rendering of the first collapsed view of the first query result and the rendering of the first expanded view of the first query result.

17. The system of claim 14, comprising a view determination component configured to identify a viewable size of a display window within which query results are rendered.

18. The system of claim 17, the collapsed view rendering component configured to perform one or more of:
render the first query result inside a display edge of the viewable size of the display window in the first collapsed view;
collapse at least the second query result outside the display edge of the viewable size of the display window in the second collapsed view; and
render at least the second query result inside the display edge of the viewable size of the display window in the second collapsed view.

19. The system of claim 14, one or more of:
the first expanded view comprising at least a body of the first query result; and
at least one of the first collapsed view not comprising the body of the first query result and the second collapsed view not comprising a body of the second query result.

20. A computer readable medium comprising computer executable instructions that when executed via a processor perform a method for rendering query results, comprising:
receiving at least a first query result and a second query result;
rendering the first query result in a first collapsed view, the first collapsed view not comprising a body of the first query result; and
upon receiving a first indication of scrolling:
rendering the first query result in a first expanded view, the first expanded view comprising at least the body of the first query result; and
rendering the second query result in a second collapsed view, the second collapsed view not comprising a body of the second query result.
